(19) United States
(12) Patent Application Publication
(10) Pub. No.: US 2006/0170638 A1
(43) Pub. Date: Aug. 3, 2006

(54) Video driver with integrated sample-and-hold amplifier and column buffer

(75) Inventors: Willem A Sloof, Cortlandt Manor, NY (US); Jin Kim, San Jose, CA (US); Byung H. Yu, San Jose, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/539,977

(22) PCT Filed: Dec. 11, 2003
(86) PCT No.: PCT/IB03/05988

§ 371 Date: Jun. 19, 2005

Related U.S. Application Data
(60) Provisional application No. 60/435,248, filed on Dec. 20, 2002.

(51) Int. Cl. G09G 3/36

(52) U.S. Cl. 345/98

(57) ABSTRACT

A video driver includes an input stage (320, 322, 324) adapted to receive a video input signal (aMP-iN), an output stage (330, 332, 334) adapted to provide a video output signal (aMP-oUT) to charge a capacitor, a feedback path (330, 322) between the output stage and the input stage adapted to cause the video output signal to follow the video input signal, and sample-and-hold means (380, 390) for selectively turning off the output stage to disable further charging of the capacitor. In one embodiment, the output stage includes complementary transistors (332, 334) connected in series between a first supply voltage (VDD) and a second supply voltage (End). The sample-and-hold means includes a first sample-and-hold switch (380) connected between a control input (307) of a first one of the complementary transistors and the first supply voltage, and a second sample-and-hold switch (390) connected between a control input (309) of a second one of the complementary transistors and the second supply voltage.

This invention pertains to the video driving circuitry, and more particularly, to a video driver that is well adapted for use with a liquid crystal display (LCD), such as a liquid crystal on silicon (LCOS) display.

A liquid crystal display (LCD), including a liquid crystal on silicon (LCOS) display, includes a plurality of pixels arranged in a matrix of rows and columns. For example, a typical LCD may have several hundred (e.g., 768) horizontal lines or rows, where each row includes a large number of pixels (e.g., 1280 pixels) arranged in a corresponding number of columns. The display further includes a plurality of row (select) lines and a plurality of column (data) lines, and each pixel is disposed at an area corresponding to where one of the row lines and one of the column lines intersect, the pixel being connected to the corresponding row line and column line. When the LCD is an active matrix LCD including a pixel transistor, then the row line is connected to a gate of the pixel transistor and column line is connected to a source (or drain) of the pixel transistor. In such a case, the row (select) lines are also often referred to as gate lines, and the column (data) lines are also often referred to as source lines.

To show an image on such a display, a video signal is vertically scanned on a row-by-row basis. That is, during a video frame, each horizontal line (row) of pixels is activated one at a time to write video data into the plurality of pixels in that line. After writing the video data into all the pixels of a row during one horizontal line interval, the row is deactivated and the pixels in that row store the video data until the next frame, while new video data is written into the remainder of the rows of the display.

An LCD device employs driver circuitry to write the video data into the pixels of a selected row. More specifically, an LCD device typically includes a row (gate) driver circuit and a column (video) driver circuit for writing video data into the pixels of the display. The row driver circuit activates the rows one by one. During each horizontal line interval, a video driver applies a desired voltage signal to each column to cause the associated pixels to store desired video data.

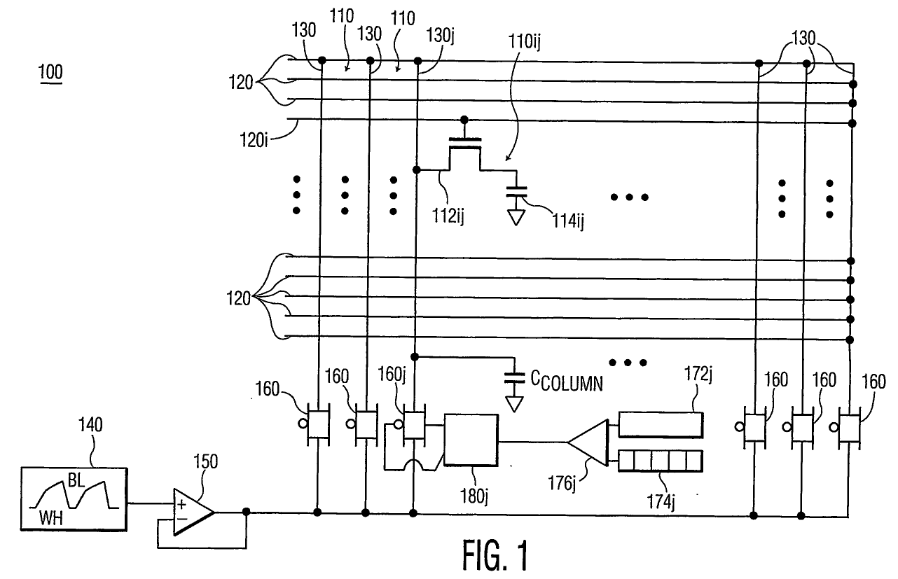

FIG. 1 shows one embodiment of a video display device 100 device (N rows by M columns), for explaining an operation of exemplary video driver. The exemplary video display device 100 is an active matrix LCOS device, although the principles explained below can be applied more generally.

The display device 100 includes a plurality of pixels 110 each arranged at an intersection of a corresponding row line 120 and a corresponding column line 130. Each pixel 110 includes a switching transistor 112 and a storage (pixel) capacitor 114. The display driving circuitry includes a ramp generator 140, a line-driving buffer amplifier 150 connected to an output of the ramp generator 140, and a plurality of sample-and-hold (S/H) transmission gates 160, each S/H transmission gate 160 being connected between an output of the line-driving buffer amplifier 150, and a corresponding one of the column lines 130. Associated with each S/H transmission gate 160 are a counter 172, a video data register 174, a comparator 176, and a level shifter 180, which will be explained in more detail below.

An explanation of the operation of the display device 100 will now be provided.

As noted above, a row driver circuit (not shown) applies a row activation signal to each row line 120, one at a time, to enable the corresponding rows of pixels 110 to write new video data therein. The period of time wherein a row of pixels is enabled to write new video data therein is referred to herein as a horizontal line interval.

At the start of each horizontal line interval, the counters 172 associated with the column lines 130 are all reset. Depending upon whether the counters 172 count up or down, they may be reset to “zero” or to their maximum count value. In the example describe herein, it will henceforth be assumed that the counters count up, and are therefore reset to zero. Meanwhile, at the start of each horizontal line interval, a digital “gray level” video data word is written into each of the video data registers 174 for each column line 130. The video data word indicates video data to be written into a corresponding pixel and stored therein for the next video frame. After the video data word is written into the video data register 174, the counter 172 begins counting. The comparator 176 compares the video data word to the output of the counter 172 and produces therefrom a comparison signal. The comparison signal indicates whether the count value of the counter 172 exceeds the value of the video data word stored in the video data register 174.

Therefore, in each horizontal line interval, the comparison signal will have a first logical value (e.g., “1”) until the counter 172 counts up to a count value that exceeds the value of video data word stored in the video data register 174, at which time it will switch over to a second logical value (e.g., “0”) for the remainder of the horizontal line interval. The comparison signal is provided from the comparator 176 to the level shifter 180.

The level shifter 180 has two complementary output terminals that are connected to two control terminals of the corresponding S/H transmission gate 160. From the comparison signal, the level shifter 180 produces complementary sample-and-hold (S/H) control signals on the two complementary output terminals that are level-shifted to voltage levels (e.g., 0-15 volts) which are effective to control a switching operation of the S/H transmission gate 160.

Meanwhile, during each horizontal line interval, the ramp generator 140 generates a voltage ramp which starts, for example, at a voltage level corresponding to a “white” pixel (fully-on), and ramps up to a voltage level corresponding to “black” pixel (fully-off). The voltage ramp is provided from the ramp generator 140 to a line driving buffer amplifier 150. The line driving buffer amplifier 150 outputs a buffered voltage ramp with sufficient drive capability to drive many column lines 130.

In response to the complementary sample-and-hold (S/H) control signals provided to the two control terminals thereof, each S/H transmission gate 160 acts as a switch to selectively connect the corresponding column line 130 to the buffered voltage ramp output by the line driving buffer amplifier 150.

The operation will now be explained in more detail, considering an exemplary pixel 110ij connected to an exemplary row line 120i and an exemplary column line 130j.

During a horizontal line interval “Tᵢ,” the exemplary row line 120i is activated by the row driver (not shown). As explained above, at that time a video data word is stored in the video data register 174j and the counter 172j begins to count up from zero. So long as the count value of the counter 172j is less than the value of the video data word stored in the video data register 174j, the complementary sample-and-hold (S/H) control signals from the level shifter 180j operate to “close” the S/H transmission gate 160j and thereby provide the voltage ramp from the line driving buffer amplifier 150 to the column line 130j as a video signal. Since the pixel 110ij is connected to the activated row line 120i, the switching transistor 112ij is turned on to connect the column line 130j to the pixel capacitor 114ij. Therefore, the voltage ramp charges the voltage on the pixel capacitor 114ij, thereby writing video data therein. The pixel capacitor 114ij continues to charge so long as the S/H transmission gate 160j is closed.

Once the count value of the counter 172j becomes greater than the value of the video data word stored in the video data register 174j, then the complementary sample-and-hold (S/H) control signals from the level shifter 180j operate to “open” the S/H transmission gate 160j and thereby disconnect the voltage ramp output by the line driving buffer amplifier 150 from the column line 130j. At that time, whatever voltage has been charged into the pixel capacitor 114ij remains stored therein until the row line 120i is activated again during the next video frame. As can be easily understood, to increase the value of the video data written and stored in the pixel capacitor 114ij in the above example, then a video controller must write a video data word with a larger value into the video data register 174j, thereby maintaining the “ON” state of the S/H transmission gate 160j for a longer period of time to enable the voltage ramp to charge the pixel capacitor 114ij to a greater value. Conversely, to decrease the value of the video data written and stored in the pixel capacitor 114ij in the above example, then a video controller must write a video data word with a smaller value into the video data register 174j.

Thus, video data is written into, and stored in, all of the pixels 110ix (x: 1 to M) associated with row line 120i during the horizontal line interval Tᵢ in accordance with the different video data words stored in each of the video data registers 174x (x: 1 to M). This process is repeated for each row line 120y (y: 1 to N) to store an entire video frame into all of the pixels 110 of the display device 100.

Unfortunately, there are shortcomings with the operation of the video driver circuit described above. Principally, it is very difficult to drive a large number of column lines 130 (e.g., 1280 column lines) with a single line driving buffer amplifier 150. For example, in an exemplary LCOS device, the line driving buffer amplifier 150 must operate with a bandwidth of 20-30 MHz and a peak output current capability of 1 Amp.

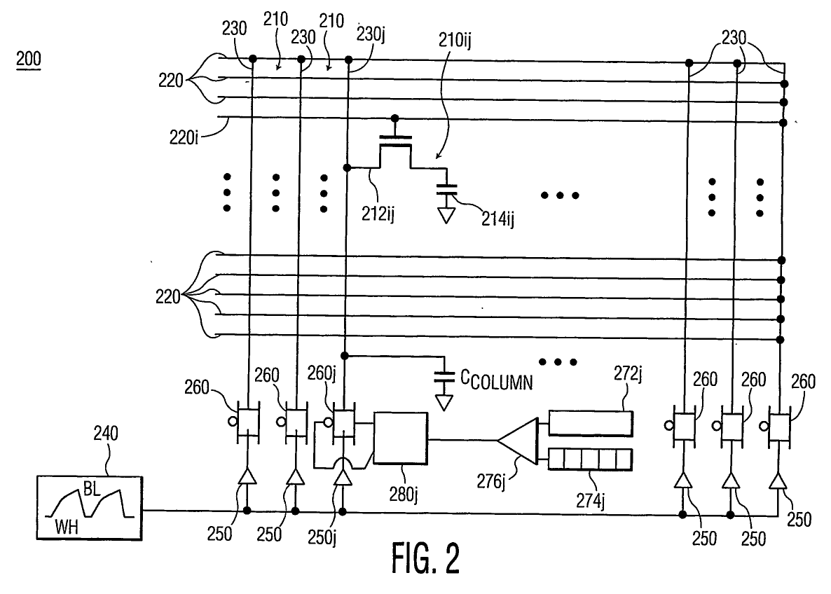

FIG. 2 shows another embodiment of a video display device 200 that addresses this problem. The operation of the video display device 200 is the same as that of the video display device 100, so an explanation thereof will be omitted here. The primary difference between the video display device 200 and the video display device 100 is that the video display device 200 includes a plurality of line driving buffer amplifiers 250, one associated with each column line 230.

Unfortunately, there are also shortcomings to the video display device 200. First, the inclusion of a dedicated line driving buffer amplifier 250 for each column requires a large amount of circuitry (e.g., a typical LCOS display device 200 may have 1280 column lines, therefore requiring 1280 separate line driving buffer amplifiers 250). This consumes an undesirably large amount of silicon area in an LCOS device.

There are other shortcomings to both of the above-described video driver circuits. First, the S/H transmission gates in the video display devices 100 and 200 need to have a low impedance. Therefore, these S/H transmission gates are relatively large transistors, adding to the amount of silicon area in an LCOS device that is consumed by the video driver circuit. Second, the S/H transmission gate suffers from significant charge feedthrough causing an undesirable sampling offset in the sample-and-hold process.

Accordingly, it would be desirable to provide a video driver circuit that occupies a reduced silicon area. It would also be desirable to provide a video driver circuit that exhibits reduced charge feedthrough. It would be still further desirable to provide an LCOS device including a video driver circuit that occupies less area and exhibits reduced charge feedthrough. The present invention is directed to addressing one or more of the preceding concerns.

In one aspect of the invention, a video driver for a display device comprises: a buffer amplifier adapted to receive and buffer a voltage ramp input signal, the buffer amplifier comprising, an input stage adapted to receive the voltage ramp input signal, and an output stage adapted to output a video output signal, the output stage comprising a pair of output stage transistors connected in series between a first supply voltage and a second supply voltage, and a feedback path between the output stage and the input stage adapted to cause the video output signal to follow the voltage ramp input signal when the output stage is enabled; and a first sample-and-hold switch arranged between a control terminal of a first one of the output stage transistors and the first supply voltage, the first sample-and-hold switch being responsive to a first sample-and-hold control signal to selectively connect the control terminal of the first one of the output stage transistors to the first supply voltage and turn off the first one of the output stage transistors; and a second sample-and-hold switch arranged between a control terminal of a second one of the output stage transistors and the second supply voltage, the second sample-and-hold switch being responsive to a second sample-and-hold control signal to selectively connect the control terminal of the second one of the output stage transistors to the second supply voltage and turn off the second one of the output stage transistors.

In another aspect of the invention, a video driver for a display device comprises: an input stage adapted to receive a voltage ramp input signal; an output stage adapted to provide a video output signal to charge a capacitor; a feedback path between the output stage and the input stage adapted to cause the video output signal to follow the voltage ramp input signal to charge the capacitor when the output stage is enabled; and sampling means for selectively disabling the output stage to disable further charging of the capacitor.

In yet another aspect of the invention, a video driver for a display device, comprises: an amplifier adapted to receive a voltage ramp signal and to output a video output signal to charge a capacitor; and sampling means for selectively disabling the amplifier from further outputting the video output signal, to disable further charging of the capacitor and maintain a voltage previously charged thereon.

FIG. 1 shows one embodiment of a display device;

FIG. 2 shows another embodiment of a display device;

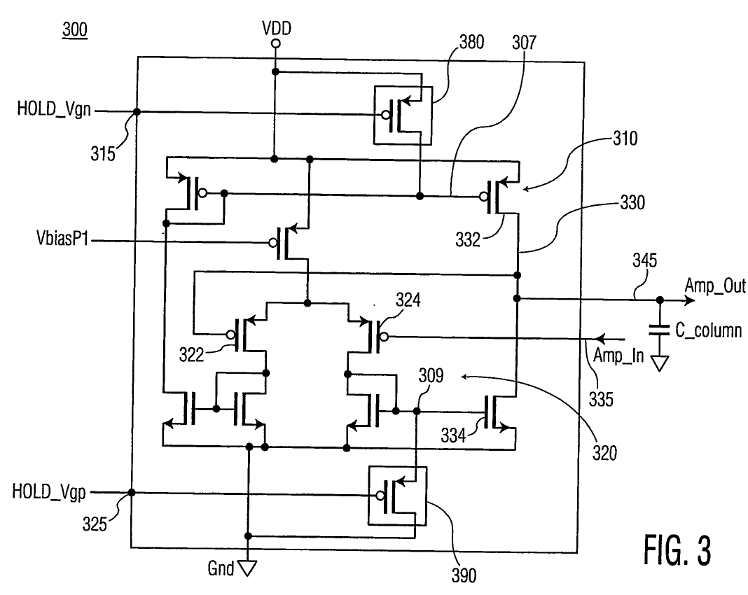

FIG. 3 shows a first embodiment of a video driver for a display device;

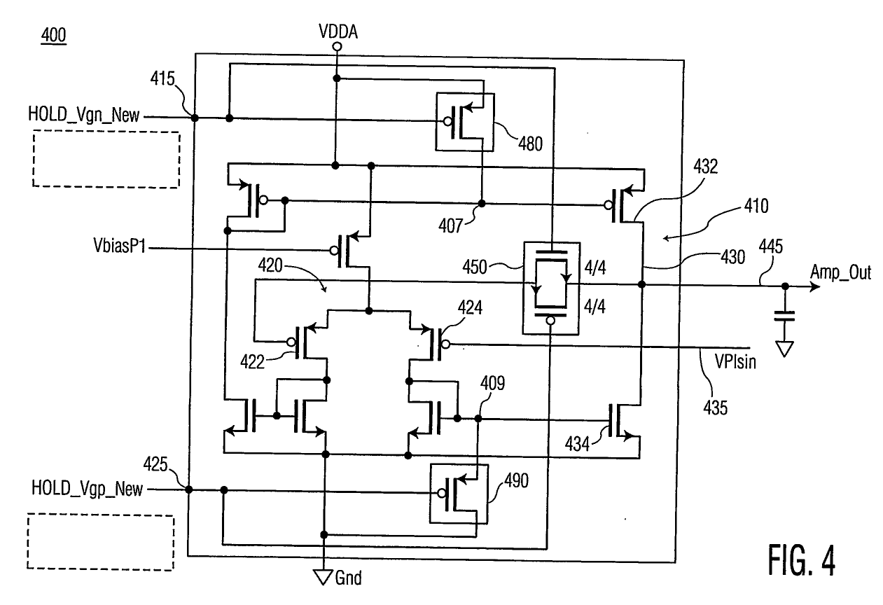

FIG. 4 shows a second embodiment of a video driver for a display device;

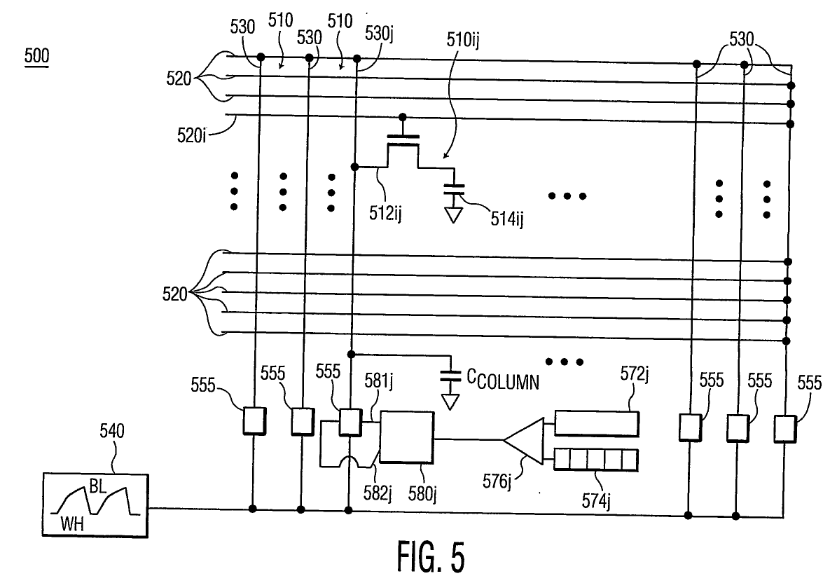

FIG. 5 shows a display device including the video driver of either FIG. 3 or FIG. 4.

FIG. 3 shows a first embodiment of a video driver 300 for a display device according to one or more aspects of the invention. The video driver 300 comprises an integrated sample-and-hold and buffer amplifier. The video driver 300 includes a buffer amplifier 310, a first sample-and-hold (S/H) switch 380 connected between a first output control terminal 307 of the buffer amplifier 310 and a first supply voltage V_{dd}, and a second sample-and-hold (S/H) switch 390 connected between a second output control terminal 309 of the buffer amplifier 310 and a second supply voltage Vₛₛ (e.g., ground).

The buffer amplifier 310 includes an input stage 320 and an output stage 330. The input stage includes a differential pair of transistors 322 and 324. The output stage 330 includes a pair of transistors 332 and 334 connected in series between the first supply voltage and the second supply voltage.

The gate of transistor 324 of the input stage 320 is connected to a video input terminal 335 of the video driver 300. Meanwhile, the output transistor pair 332, 334 are connected to a video output terminal 345 of the video driver 300. A feedback signal connects the video output terminal 345 to the gate of transistor 322 of the input stage 320, providing a feedback signal from the output stage to the input stage. Also, control terminals of the first and second S/H switches 380, 390 are connected to complementary S/H control input terminals 315, 325 of the video driver 300.

An explanation of the operation of video driver 300 will now be provided in the context of an exemplary LCOS display device in which it may be utilized.

FIG. 5 shows an exemplary LCOS display device 500. The operation of the video display device 500 is generally the same as that of the video display devices 100 and 200, so a detailed explanation thereof will be omitted here. The primary difference between the video display device 500 and the video display device 200 is that the video display device 500 includes a plurality of video drivers 555, one associated with each column line 530, in place of the line driving buffer amplifiers 250 and the S/H transmission gates 260 of the video display device 200. Each video driver 555 may be embodied by the video driver 300 of FIG. 3, and in the discussion to follow, it is assumed that the video driver 555 corresponds to the video driver 300 of FIG. 3.

Turning to FIGS. 3 and 5, the output of the ramp generator 540 is connected to the video input terminal 335 of the video driver 300 to supply the voltage ramp thereto. Meanwhile, the video output terminal 345 of the video driver 300 is connected to the column line 530j. Also, the two complementary output terminals 581, 582 are connected respectively to the complementary S/H control terminals 315, 325 of the video driver 300 to provide the complementary sample-and-hold (S/H) control signals thereto.

At the start of a horizontal line interval, so long as the count value of the counter 572j is less than the value of the video data word stored in the video data register 574j, the complementary S/H control signals from the level shifter 580j have a first output state (e.g., output terminal 581 has a positive voltage such as +15V, and output terminal 582 has a ground voltage). When the complementary S/H control signals provided to the S/H control terminals 315, 325 of the video driver 300 have the first output state, the first and second S/H switches 380, 390 are opened (the transistors are turned off). Accordingly, the video driver 300 operates in a “tracking mode” such that the output stage 330 of the video driver 300 provides the voltage ramp from the video input terminal 335 to the video output terminal 345 connected to the column line 530j. When the row line 520i connected to pixel 510ij is activated, then the switching transistor 512ij is turned on to connect the row line 530j to the pixel capacitor 514ij. Therefore, the voltage ramp charges the voltage on the pixel capacitor 514ij, thereby writing video data therein. The pixel capacitor 514ij continues to charge so long as the output stage 330 is activated.

Once the count value of the counter 572j becomes greater than the value of the video data word stored in the video data register 574j, then the complementary sample-and-hold (S/H) control signals from the level shifter 580j change to a second output state (e.g., output terminal 581 has a ground voltage, and output terminal 582 has a positive voltage, such as +15V). When the complementary S/H control signals provided to the S/H control terminals 315, 325 of the video driver 300 have the second output state, then the first and second S/H switches 380, 390 are closed (the transistors are turned ON) to thereby connect the output control terminal 307 to the first supply voltage, and to connect the output control terminal 309 to the second supply voltage. This turns-off the transistors 332 and 334 of the output stage 330 to prevent further charging of voltage onto the column line 530j and thereby to the pixel capacitor 514ij. Accordingly, the video driver 300 now operates in a “hold mode.” At that time, whatever voltage has already been charged into the pixel capacitor 514ij remains stored therein until the row line 520i is activated again during the next video frame.

Advantageously, the S/H switches 380, 390 are not arranged in the current path charging the pixel capacitors 514. Therefore, the impedance of each S/H switch 380, 390 is not as critical as the impedance of the S/H transmission gate 160, 260 of FIGS. 1 and 2. Accordingly, the S/H switches 380, 390 can be significantly smaller than the transistors of the S/H transmission gates 160, 260 of FIGS. 1 and 2, so the amount of silicon area required is less. Also, the output stage transistors 332, 334 operate in a different mode than that of the complementary transistor pair in the S/H transmission gates 160, 260 of FIGS. 1 and 2. Therefore, voltage feedthrough is reduced and sampling accuracy is improved with the video driver 300 comprising an integrated sample-and-hold and buffer amplifier.

Meanwhile, FIG. 4 shows a second embodiment of a video driver 400 for a display device according to one or more aspects of the invention. The second embodiment video driver 400 differs from the first embodiment video driver 300 by the inclusion of a transmission gate 450 in the feedback path between the output of the output stage 430 and the input stage 420. The transmission gate 450 has two control terminals connected to the S/H control terminals 415, 425 of the video driver 400.

An explanation of operation of the transmission gate 450 in the video driver 400 will now be provided in the context of the exemplary LCOS display device 500 in which it may be utilized. In the following explanation, it is understood that the operation of the S/H switches 480, 490 is the same as the operation of the S/H switches 380, 390 of FIG. 3, and so a detailed discussion thereof will not be repeated here.

Operationally, when the complementary S/H control signals provided to the S/H control terminals 415, 425 of the video driver 400 have the first output state, the transistors of the transmission gate 450 are each turned ON to connect the feedback path from the output stage 430 to the input stage 420. Accordingly, the video driver 400 operates in the “tracking mode” to charge the pixel capacitor 514ij, thereby writing video data therein. Then, when the complementary S/H control signals provided to the S/H control terminals 415, 425 of the video driver 400 have the second output state, the transistors of the transmission gate 450 are each turned OFF to disconnect the feedback path from the output stage 430 to the input stage 420. Accordingly, the video driver 400 operates in the “hold mode” and whatever voltage has already been charged into the pixel capacitor 514ij remains stored therein until the row line 520i is activated again during the next video frame.

Advantageously, the transmission gate 450 improves the sampling accuracy, further reducing a charge coupling between the video input terminal 435 and the video output terminal 445 while operating in the “hold mode.”

while preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A video driver for display device, comprising:
a buffer amplifier adapted to receive and buffer a voltage ramp input signal, the buffer amplifier comprising,
an input stage adapted to receive the voltage ramp input signal, and
an output stage adapted to provide a video output signal, the output stage comprising a pair of output stage transistors connected in series between a first supply voltage and a second supply voltage,
and a feedback path between the output stage and the input stage adapted to cause the video output signal to follow the voltage ramp input signal when the output stage is enabled; and
a first sample-and-hold switch arranged between a control terminal of a first one of the output stage transistors and the first supply voltage, the first sample-and-hold switch being responsive to a first sample-and-hold control signal to selectively connect the control terminal of the first one of the output stage transistors to the first supply voltage and turn off the first one of the output stage transistors; and
a second sample-and-hold switch arranged between a control terminal of a second one of the output stage transistors and the second supply voltage, the second sample-and-hold switch being responsive to a second sample-and-hold control signal to selectively connect the control terminal of the second one of the output stage transistors to the second supply voltage and turn off the second one of the output stage transistors.

2. The video driver of claim 1, wherein the first and second sample-and-hold switches each comprise a transistor.

3. The video driver of claim 1, further comprising a pair of sample-and-hold control terminals connected to control terminals of the first and second sample-and-hold switches and providing thereto the first and second sample-and-hold control signals.

4. The video driver of claim 1, further comprising a transmission gate in the feedback path between the output stage and the input stage.

5. The video driver of claim 4, wherein the transmission gate comprises a complementary pair of transistors.

6. The video driver of claim 5, further comprising a pair of sample-and-hold control terminals connected to control terminals of the complementary pair of transistors of the transmission gate.

7. A video driver for a display device, comprising:
an input stage adapted to receive a voltage ramp input signal;
an output stage adapted to provide a video output signal to charge a capacitor;
a feedback path between the output stage and the input stage adapted to cause the video output signal to follow the voltage ramp input signal to charge the capacitor when the output stage is enabled; and
sampling means for selectively disabling the output stage to disable further charging of the capacitor.

8. The video driver of claim 7, wherein the sampling means comprises a sample-and-hold switch arranged between an output control terminal of the output stage and a supply voltage.

9. The video driver of claim 8, wherein the sampling means comprises a second sample-and-hold switch arranged between a second output control terminal of the output stage and a second supply voltage.

10. The video driver of claim 9, wherein the output stage includes a pair of transistors connected in series, and wherein the first and second output control terminals are connected to gates of the pair of transistors.

11. The video driver of claim 7, further comprising a transmission gate in the feedback path between the output stage and the input stage.

12. The video driver of claim 11, wherein the transmission gate comprises a complementary pair of transistors.

13. The video driver of claim 12, further comprising a pair of sample-and-hold control terminals connected to control terminals of the complementary pair of transistors of the transmission gate.

14. A video driver for a display device, comprising:
an amplifier adapted to receive a voltage ramp signal and to output a video output signal to charge a capacitor; and
sampling means for selectively disabling the amplifier from further outputting the video output signal, to disable further charging of the capacitor and maintain a voltage previously charged thereon.

15. The video driver of claim 14, wherein the amplifier comprises at least one output control terminal, and wherein the sampling means comprises a sample-and-hold switch arranged between the output control terminal and a supply voltage.

16. The video driver of claim 14, wherein the wherein the amplifier comprises first and second control terminals, and wherein the sampling means comprises first and second sample-and-hold switches arranged respectively between the first output control terminal and a first supply voltage and between the second output control terminal and a second supply voltage.

17. The video driver of claim 16, wherein the amplifier includes a pair of transistors connected in series, and wherein the first and second output control terminals are connected to gates of the pair of transistors.

18. The video driver of claim 14, further comprising a transmission gate in a feedback path of the amplifier.

19. The video driver of claim 18, wherein the transmission gate comprises a complementary pair of transistors.

20. The video driver of claim 19, further comprising a pair of sample-and-hold control terminals connected to control terminals of the complementary pair of transistors of the transmission gate.
